(19) United States
(12) Patent Application Publication
(10) Pub. No.: US 2010/0320780 A1
(43) Pub. Date: Dec. 23, 2010

(54) Composite vehicle bumper using recycled rubber

(75) Inventor: Kenneth P. Glynn, Flemington, NJ (US)

Correspondence Address: Kenneth P. Glynn, 24 Mine Street, Flemington, NJ, 08822, US

(73) Assignee: B Green Innovations, Inc.

(21) Appl. No.: 12/456,549

(22) Filed: Jun. 18, 2009

(51) Int. Cl. B60R 19/26

(52) U.S. Cl. 293/132

(57) ABSTRACT

A recycled rubber, preferably recycled tire rubber, based composite bumper for vehicles includes: a) a core member cast into a predetermined shape for attachment to a vehicle to function as an impact bumper core, the core member being a cast recycled rubber core member; and, b) a skin member, the skin member being attached to at least a portion of the core member, the skin member being selected from the group consisting of a urethane, a urethane-derived polymer, a thermoplastic and combinations thereof. In some embodiments, there is at least one rigid support member embedded in the core member to add strength to the bumper.

### BACKGROUND OF INVENTION

a. Field of Invention

The invention relates generally to composite vehicle bumpers recycled tires. These bumpers may be used for any type of vehicle and may be used for front, back, and in some cases, side bumpers. By “bumpers” is meant the position of an external aspect of a vehicle that is made to reduce harm from impact to the vehicle, typically in the front or back of the vehicle. Thus, the present invention may be utilized in conjunction with automobiles, trucks, three wheelers, buses, school buses, trailers and military and special functioning vehicles, such as trades vehicles, cherry pickers, motorized lifts and tractors.

b. Description of Related Art

The following patents are representative of the field of this invention:

U.S. Pat. No. 7,267,738 B2 to Czaplicki et al. describes a synthetic material and articles incorporating the same are disclosed. The synthetic material includes a base material, which is at least partially tacky. Preferably, a powder is dispensed upon the base material for providing a substantially non-tacky surface to the synthetic material. The materials and articles are used, among other things, for motor vehicles.

U.S. Pat. No. 6,777,524 B1 to Shimizu et al. describes a polyether polyurethane comprising (A) at least one polyisocyanate having two or more isocyanate groups, which is selected from the group consisting of an aromatic polyisocyanate and an aliphatic polyisocyanate; (B) a polyoxytetramethylene glycol (PTMG) having a number average molecular weight of from 500 to 4,000, a molecular weight distribution (Mw/Mn) of 1.75 or less, and a content of high molecular weight PTMG molecules of 10% by weight or less; and (C) at least one chain extender selected from the group consisting of a C₂-C₁₀ polyol having two or more hydroxyl groups and a C₂-C₁₀ polyamine having two or more amino groups. Also disclosed is a urethane prepolymer which comprises the above-mentioned components (A) and (B) and which has terminal isocyanate groups.

U.S. Pat. No. 6,747,094 B2 to Kinoshita describes a high-impact thermoplastic resin composition comprising: (A) 5 to 95 parts by weight of a thermoplastic elastomer comprising a partially or completely crosslinked saturated rubber-like polymer and a polyolefinic resin and/or a polystyrene-based resin, or a mixture of said thermoplastic elastomer and a polyolefinic resin; and (B) 95 to 5 parts by weight of at least one thermoplastic resin selected from the group consisting of polystyrene-based resins, polyamide-based resins, polyurethane-based resin, polycarbonate-based resins, polyphenylene ether-based resins, polyester-based resins, acrylic resins, polyacetal-based resins and polyphenylene sulfide-based resins, the total of the components a) and b) being 100 parts by weight, wherein the amount of the saturated rubber-like polymer in the composition is 1 to 40% by weight.

U.S. Pat. No. 5,957,073 describes a dampening a shield structure such as a fender with a plurality of resilient laminated bumpers. A plurality of these bumpers each have a two or more elastic laminae or layers. In each such multiple layer bumper, at least one of the lamina is folded to enclose at least one other lamina, so that the folded laminae and any laminae they enclose form a laminated loop. Alternate embodiments have a bumper loop that has at least one lamina that is not folded. Some embodiments have substantially different length laminae folded into a laminated loop such that there are definite spaces between one or more adjacent pairs of lamina. The number of laminae comprising the laminated loops can vary. Another embodiment is a mechanically floating fender flexibly mounted to elastically intercede during a collision. The floating fender has a plurality of bumpers which may be single layer or laminated, and the bumper loops are oriented to be continually in contact with the structure on which the fender is mounted. The floating mounting is effected by connecting the fender to the mounting structure (such as a boat hull) with lengths of some flexible connecting material such as chain.

U.S. Pat. No. 5,532,309 to Fukui et al. describes a resin composition for an automobile bumper comprising components (A), (B), and (C) described below: (A) 45 to 74% by weight of a crystalline ethylene-propylene block copolymer having (a) a flexural modulus of 15,000 kg/cm² or more, (b) an ethylene content of 5 to 20% by weight, (c) an intrinsic viscosity (decalin, 135° C.) of a portion soluble in p-xylene at room temperature of 3 or more, (d) a melt flow index (MI) of 21 to 70 g/10 min., and (e) a content of a portion insoluble in boiling n-heptane of 97% by weight or more; (B) 21 to 35% by weight of elastomer selected from the group consisting of components (I), (II) and (III) and having a weight ratio of (I): [(I)+(II)+(III)] of from 0.5 to 1.0, (a) said component (1) being an amorphous ethylene-butene copolymer having a butene content of 10 to 25% by weight and a Mooney viscosity value, (ML₁₊₄, 100° C.) of 5 to 20, (b) said component (II) being an amorphous ethylene-propylene copolymer having an ethylene content of 70 to 90% by weight and a Mooney viscosity value (ML₁₊₄, 100° C.) of 5 to 40, and (c) said component (III) being a hydrogenated block copolymer consisting of 10 to 40% by weight of an aromatic vinyl polymer block X and 60 to 90% by weight of conjugate diene polymer block Y, having a structure of said block components being X−Y or X−(Y−X)ₙ, wherein n is 1 or 2, 90 mol % or more of said block Y being hydrogenated and the melt flow index (MI) of the hydrogenated block copolymer being 5 g/10 min. (230° C., 2.16 kg) or more, and; (C) 5 to 10% by weight of talc having a combustion loss of 7% by weight or less, containing no particles having a diameter of 10 μm or more and having an average particle diameter D₅₀ of 1.0 to 3.0 μm.

U.S. Pat. No. 4,737,536 to Kawase et al. describes an automobile bumper which is formed of a thermoplastic multicomponent resin composition and which is improved in weatherability and impact resistance at low temperatures and also in surface glossiness. Essentially the resin composition is a blend of 22-28 wt % of a hydrogenated block copolymer of an aromatic vinyl compound such as styrene and a conjugated diene such as butadiene, 32-56 wt % of a propylene-ethylene block copolymer in which the content of ethylene is 1-10 wt % and 22-28 wt % of an ethylene-propylene copolymer rubber. Optionally, up to 5 wt % of talc and/or up to 7 wt % of low-pressure low-density poly-ethylene may be added. Some physical properties of the ingredients are specified such that the resin composition has a melt index not lower than 5 g/10 min at 230° C. under load of 2.16 kg and a modulus of elasticity in bending in the range from 2000 to 4000 kg/cm².

U.S. Pat. No. 4,107,106 to Dunleavy et al. describes an invention that relates to the use of phenol-aldehydeamine resin/diol curatives in the production of cellular polyurethane elastomers having outstanding energy absorbing properties. The elastomers are useful as energy managing components in automobiles and the like.

Notwithstanding the prior art, the present invention is neither taught nor rendered obvious thereby.

### SUMMARY OF THE INVENTION

The present invention relates to recycled rubber, preferably recycled tire rubber-based composite bumper for vehicles. The invention includes: a) a core member cast into a predetermined shape for attachment to a vehicle to function as an impact bumper core, the core member being a cast recycled rubber core member; and, b) a skin member, the skin member being attached to at least a portion of the core member, the skin member being selected from the group consisting of a urethane, a urethane-derived polymer, a thermoplastic and combinations thereof.

In some preferred embodiments of the present invention composite bumper for vehicles, the core member is composed at least of a binder and rubber, the rubber being shredded recycled rubber.

In some preferred embodiments of the present invention composite bumper for vehicles, the recycled rubber is recycled tire rubber.

In some preferred embodiments of the present invention composite bumper of vehicles, the skin member is a urethane.

In some preferred embodiments of the present invention composite bumper of vehicles, the skin member is a urethane-derived polymer.

In some preferred embodiments of the present invention composite bumper of vehicles, the skin member is a thermoplastic.

In some preferred embodiments of the present invention composite bumper of vehicles, the thermoplastic is selected from the group consisting of polyamides, polyolefins, polyethylene, polyvinyl chlorides, polypropylene, polyethylene and combinations thereof.

In some preferred embodiments of the present invention composite bumper of vehicles, the composite bumper includes attachment means connected to the core member for attachment to a vehicle that includes at least two protrusions.

In some preferred embodiments of the present invention composite bumper of vehicles, the composite bumper includes a plurality of orifices for attachment to a vehicle.

In some preferred embodiments of the present invention composite bumper of vehicles, the composite bumper further includes at least two cut-outs for vehicle lighting.

In some preferred embodiments of the present invention composite bumper for vehicles, the invention includes: a) a core member cast into a predetermined shape for attachment to a vehicle to function as an impact bumper core, the core member being a cast recycled rubber core member; b) a skin member, the skin member being attached to at least a portion of the core member, the skin member being selected from the group consisting of a urethane, a urethane-derived polymer, a thermoplastic and combinations thereof; and, c) at least one rigid support member embedded in the core member to provide structural strength to the bumper, the support member being selected from the group consisting of metal, rigid plastic and combinations thereof.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention and are incorporated in and constitute a part of this specification, illustrate preferred embodiments of the invention and together with the detail description serve to explain the principles of the invention. In the drawings:

FIG. 1 shows a front perspective view of one embodiment of a present invention bumper attached to an automobile;

FIG. 2 shows the present invention bumper of FIG. 1 detached from an automobile in its front view;

FIGS. 3 and 4 show side cut view of variations of the present invention bumper of the type shown in FIGS. 1 and 2;

FIG. 5 illustrates a side view of an alternative embodiment present invention bumper with a partially embedded support member; and,

FIG. 6 shows a back, cut view of another present invention bumper with a fully embedded support member.

### DETAILED DESCRIPTION OF THE EMBODIMENTS

Used tires are recycled by being macerated mechanically through a series of cutters with increasingly smaller pieces being produced, from full tires, to tires with sidewall beads removed, to 9″ to 12″ pieces, to 3″ to 5″ pieces, down to an inch or less and then to smaller sizes that are tenths of an inch or less. Centrifuges or other processes remove fiber from rubber and magnets remove metal fines. The resulting crumb rubber is utilized as the major constituent in forming the products of the present invention. The crumb rubber is mixed with a binder and the mixture may include other additives, such as colorants and flame retardants. Binders may be thermoset plastics, polyvinyl chloride, urethane or other material, or combinations thereof.

The crumb rubber and binder (and other constituents, where applicable) are cold blended or hot blended and then molded into the shape of the finished paver blocks of the present invention. The molding process may be hot melt molding and hot pressure molding is preferred. The mixture is poured into an open mold and pressed into the mold with predetermined heat and pressure. The heat is typically below the melting point of the crumb rubber in terms of temperature and exposure time, but in some preferred embodiments, sufficient heating is applied to fuse the binder and crumb rubber particles together. The molded products are ejected or removed from the molds manually or automatically using ejector systems.

Specific examples of skin member materials include any of the known materials of the thermoplastic and the urethane families that have been used for bumpers. Such materials include, but are not limited to those set forth in U.S. Pat. No. 6,777,524 B1 issued on Aug. 17, 2004 to Shimizu et al. entitled “Polyether Polyurethane”; U.S. Pat. No. 6,747,094 B2 issued on Jun. 8, 2004 to Kinoshita et al. entitled “High Impact Thermoplastic Resin Composition”; U.S. Pat. No. 5,532,309 issued on Jul. 2, 1996 to Fukui et al. entitled “Resin Composition For Automobile Bumper”; U.S. Pat. No. 4,737,536 issued on Apr. 12, 1988 to Kawase et al. entitled “Automobile Bumper Formed of Thermoplastic Multicomponent Resin”; U.S. Pat. No. 4,107,106 issued on Aug. 15, 1978 to Dunleavy et al. entitled “Phenol-Aldehyde-Amine Resin/Glycol Curatives For Energy Absorbing Polyurethanes”.

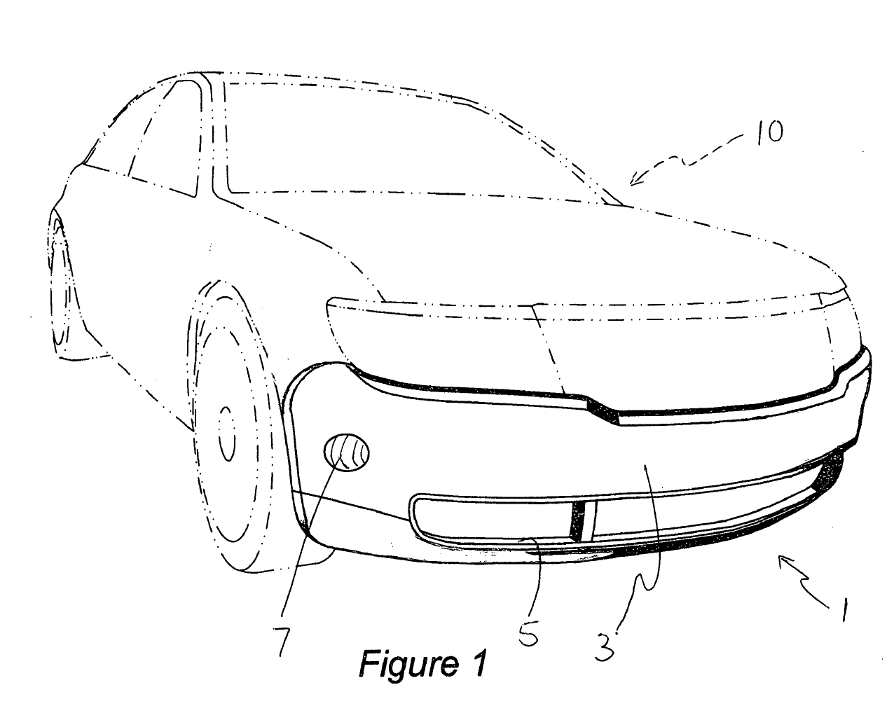

FIG. 1 shows a front perspective view of one embodiment of a present invention bumper 1 attached to an automobile 10. Bumper 1 includes a main body 3 with blinker ports 7 and 9 and a grill feature 5. FIG. 2 shows the present invention bumper 1 of FIG. 1 detached from an automobile in its front view. Identical parts are identically numbered.

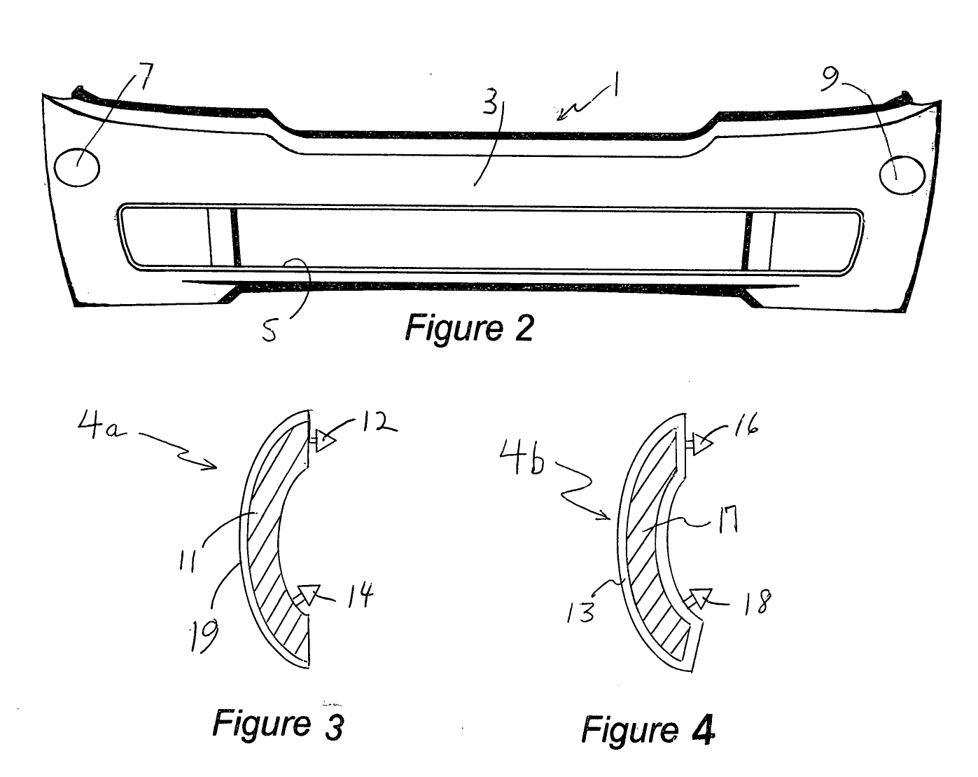

FIGS. 3 and 4 show side cut view of variations of the present invention bumper 1 of the type shown in FIGS. 1 and 2. In FIG. 3, bumper 4a includes a core member 11 that has been cast into a bumper shape with attachment means. The attachment means are snap-in cone heads 12 and 14. Alternatively, detachment means bars, male (protruding) bolts, embedded female receivers, such as threaded bolt or screw receivers. On the front of core member 11 is a skin member 19. The skin member 19 may be applied by dipping, spraying, or any other coating or deposition procedure. FIG. 4 shows an alternative bumper 4b with a core member 17 and a skin member 13. In this embodiment, all of the exposed surfaces of core member 17 are covered with skin member 13. Attachments 16 and 18 are also included.

The core member is recycled rubber product and the techniques for making recycled rubber products is known. One of the preferred methods is described in detail above. The recycled rubber is preferably recycled rubber tire product.

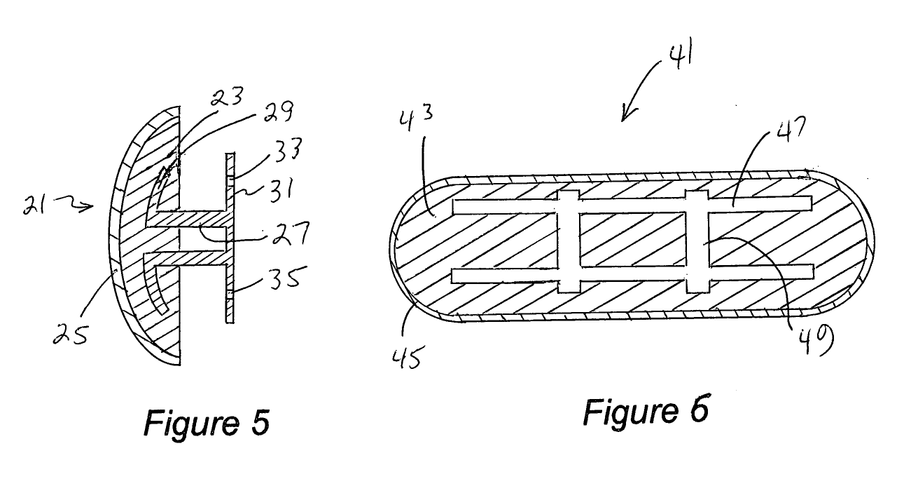

FIG. 5 illustrates a side view of an alternative embodiment present invention bumper 21 with an embedded support member. The bumper 21 has an impact absorbing core member 23 made of recycled crumb rubber product. There is a skin member 25 that may be any of the skin member materials previously described herein. The embedded support member 31 is partially embedded with hooks, such as hook 29, inside the core member 23, and partially not embedded. The extension legs, such as leg 27, extends out of the core member 23 and connects to a vertical plate with bolt holes 33 and 35, as shown.

FIG. 6 shows a back, cut view of another present invention bumper 41 with a fully embedded support member. Here, the core member 43 and its skin member 45 are cut from top to bottom, exposing internal support member 49 that includes horizontal cross members, such as cross member 47. These support members made be made of any structurally beneficial material(s) and are preferably recycled material(s). They may, for example, be made of heavy duty plastic, iron, steel or aluminum, alloy, composite, fiber, graphite or combinations thereof.

Although particular embodiments of the invention have been described in detail herein with reference to the accompanying drawings, it is to be understood that the invention is not limited to those particular embodiments, and that various changes and modifications may be effected therein by one skilled in the art without departing from the scope or spirit of the invention as defined in the appended claims. For example, in some preferred embodiments, the support member embedded in the core member may be made of diverse materials and may extend beyond the main body of the bumper (core and skin) to protrude forward and/or rearward to provide attachments for accessories or to create attachment areas.

What is claimed is:

1. A composite bumper for vehicles, which comprises:
a) a core member cast into a predetermined shape for attachment to a vehicle to function as an impact bumper core, said core member being a cast recycled rubber core member; and,
b) a skin member, said skin member being attached to at least a portion of said core member, said skin member being selected from said group consisting of a urethane, a urethane-derived polymer, a thermoplastic and combinations thereof.

2. The composite bumper for vehicles of claim 1 wherein said core member is composed at least of a binder and rubber, said rubber being shredded recycled rubber.

3. The composite bumper for vehicles of claim 2 wherein said recycled rubber is recycled tire rubber.

4. The composite bumper of vehicles of claim 1 wherein said skin member is a urethane.

5. The composite bumper of vehicles of claim 1 wherein said skin member is a urethane-derived polymer.

6. The composite bumper of vehicles of claim 1 wherein said skin member is a thermoplastic.

7. The composite bumper of vehicles of claim 6 wherein said thermoplastic is selected from the group consisting of polyamides, polyolefins, polyethylene, polyvinyl chlorides, polypropylene, polyethylene and combinations thereof.

8. The composite bumper of vehicles of claim 1 wherein said composite bumper includes attachment means connected to said core member for attachment to a vehicle that includes at least two protrusions.

9. The composite bumper of vehicles of claim 1 wherein said composite bumper includes a plurality of orifices for attachment to a vehicle.

10. The composite bumper of vehicles of claim 1 wherein said composite bumper further includes at least two cut-outs for vehicle lighting.

11. A composite bumper for vehicles, which comprises:
a) a core member cast into a predetermined shape for attachment to a vehicle to function as an impact bumper core, said core member being a cast recycled rubber core member;
b) a skin member, said skin member being attached to at least a portion of said core member, said skin member being selected from the group consisting of a urethane, a urethane-derived polymer, a thermoplastic and combinations thereof; and,
c) at least one rigid support member embedded in said core member to provide structural strength to said bumper, said support member being selected from the group consisting of metal, rigid plastic and combinations thereof.

12. The composite bumper for vehicles of claim 11 wherein said core member is composed at least of a binder and rubber, said rubber being shredded recycled rubber.

13. The composite bumper for vehicles of claim 12 wherein said recycled rubber is recycled tire rubber.

14. The composite bumper of vehicles of claim 11 wherein said skin member is a urethane.

15. The composite bumper of vehicles of claim 11 wherein said skin member is a urethane-derived polymer.

16. The composite bumper of vehicles of claim 11 wherein said skin member is a thermoplastic.

17. The composite bumper of vehicles of claim 16 wherein said thermoplastic is selected from the group consisting of polyamides, polyolefins, polyethylene, polyvinyl chlorides, polypropylene, polyethylene and combinations thereof.

18. The composite bumper of vehicles of claim 11 wherein said composite bumper includes attachment means connected to said core member for attachment to a vehicle that includes at least two protrusions.

19. The composite bumper of vehicles of claim 11 wherein said composite bumper includes a plurality of orifices for attachment to a vehicle.

20. The composite bumper of vehicles of claim 11 wherein said composite bumper further includes at least two cut-outs for vehicle lighting.
